(19) United States
(12) Patent Application Publication
(10) Pub. No.: US 2024/0180160 A1
(43) Pub. Date: Jun. 6, 2024

(54) ANTIVIRAL POLYMER MATERIAL

(71) Applicant: VALE BROTHERS LIMITED, Walsall (GB)

(72) Inventor: Peter Wilkes, Sutton Coldfield (GB)

(73) Assignee: VALE BROTHERS LIMITED, Walsall (GB)

(21) Appl. No.: 18/283,175

(22) PCT Filed: Mar. 21, 2022
(86) PCT No.: PCT/GB2022/050710

§ 371 Date: Sep. 20, 2023

(30) Foreign Application Priority Data
Mar. 22, 2021 (GB) 2103959.9

(51) Int. Cl. A01N 55/00; A01P 1/00

(52) U.S. Cl. CPC A01N 55/00; A01P 1/00

(57) ABSTRACT

The invention relates to the use of a silane-based quaternary ammonium compound as an antiviral agent. The invention also relates to an antiviral polymer material comprising a silane-based silicon quaternary ammonium compound and a polymer.

### FIELD OF THE INVENTION

The present invention relates to a silane-based quaternary ammonium compound and polymer material capable of exhibiting antiviral properties. The present invention also relates the uses of said antiviral compound and polymer material in human-contact articles.

### BACKGROUND OF THE INVENTION

While viruses have several modes of transmission from one host to another, a key mode of transmission involves articles that act as a stopover for the viruses. Some viruses can spread by being transported or remain live (also termed viable) on articles including hard surfaces, clothing, skin, etc. Viruses can remain viable on articles for a period of time that can be hours, days or even weeks. If a contaminated article is touched the virus may be transferred into a human or animal body and so be capable of causing disease. Thus, one key response to any viral threat is to render susceptible articles antiviral.

For example, the emergence of the new severe acute respiratory syndrome coronavirus 2 (SARS-COV-2) is an urgent issue that requires immediate action. Although the development of a vaccine is one solution, vaccine production is a process requiring a considerable amount of time. Thus, there is a strong demand for other methods that can prevent SARS-COV-2 from spreading. Additionally new strains of virus occur every year with potential immunity from previously formulated vaccines.

Potential ways in which SARS-COV-2 and other viruses can be spread include touching people or articles that are contaminated with infectious droplets followed by touching of eye (s), nose, or mouth. This can happen when someone who is sick with SARS-COV-2 coughs or sneezes droplets onto themselves, other people, or nearby articles which are then touched by other people. This is also the case for any enveloped virus.

Accordingly, there is an urgent need for antiviral materials that can prevent infection from touching articles and prevent viruses, such SARS-COV-2, from spreading.

EP2007402A2 describes a method of treating surfaces for preventing the contamination of said surface with a virus, said method comprising the step of applying to said surface a coating comprising one or more sources of silver and copper ions, said sources of silver ions and copper ions are capable of releasing silver and copper ions in an antivirally effective amount.

However, in some applications it is not desired that the antiviral compound leaks out from the articles, as this contaminates the environment with the antiviral compound. Furthermore, as the antiviral function of such a leaking article decreases with time, such an article will be unsuited for repeated use.

Thus, for many applications, it may be advantageous to irreversibly bind the antiviral compound to the article, thus making it retain its antiviral effect even after a long period of time or after one or more washings.

There thus exists a need for eradicating viral contaminants on articles and/or preventing spread of viruses such as SARS-COV-2 through contamination of articles.

### SUMMARY OF THE INVENTION

In one aspect, the present invention provides an antiviral polymer material comprising a silane-based quaternary ammonium compound and a polymer.

In another aspect, the present invention provides use of the antiviral polymer material according to the above aspect for destroying or inactivating a virus on an article.

In another aspect, the present invention provides use of the antiviral polymer material according to the above aspect for making an article capable of destroying or inactivating a virus on an article.

In another aspect, the present invention provides a method for destroying or inactivating a virus, wherein said article comprises the antiviral polymer material of the present invention.

In another aspect, the present invention provides a method for eradicating or inactivating a virus from an article, wherein said article comprises the antiviral polymer material of the present invention.

In another aspect, the present invention provides a method of making an antiviral polymer material comprising combining a polymer and a silane-based quaternary ammonium compound.

In another aspect, the present invention provides use of silane-based quaternary ammonium compounds as antiviral agent.

In another aspect, the present invention provides an article comprising the antiviral polymer material of the present invention.

In another aspect, the present invention provides use of the antiviral polymer material of the present invention in the production of an article.

In another aspect, the present invention provides a method for manufacturing an article, wherein said method comprises forming at least part of said article from the antiviral polymer material of the present invention.

### DETAILED DESCRIPTION OF THE INVENTION

It has been surprisingly found that articles that come into contact with humans and animals, can be produced from polymers materials which have antiviral properties, e.g. polymeric materials that can prevent, reduce or inhibit the survival of a virus responsible for diseases such as SARS-COV-2 on an article.

The present invention relates to an antiviral polymer material capable of exhibiting antiviral properties and excellent handleability and safety.

It is thus possible to produce fibres, filaments, threads, molded articles, nonwoven materials, extruded articles, woven fabrics, knitted fabrics, web materials, films, sponge materials, fibrous batt materials, foam materials, sheets and textiles, which have non-leaching antiviral properties and thus can reduce viral, including SARS-CoV-2, contamination and transmission by killing or inactivating the virus when it comes into contact with the antiviral agent present.

In one aspect, the present invention provides an antiviral polymer material comprising an antiviral agent and a polymer. The antiviral agent is a silane-based quaternary ammonium compound. The antiviral agent is combined with a polymer to form an antiviral polymer material.

As will be further described herein, the term “antiviral polymer material” is intended to encompass a composition, a mixture or blend comprising a silane-based quaternary ammonium compound and a polymer. Preferably in the antiviral polymer material of the present invention the components are in intimate mixture with one another, e.g. the silane quaternary ammonium compound and the polymer are blended together, mixed together or are copolymerised with one another. Thus in one embodiment the antiviral polymer material is a blend comprising the silane-based quaternary ammonium compound and a polymer.

In the context of the present invention the term “antiviral” refers to the property of preventing or reducing viral contamination by destroying or inactivating a virus or preventing, reducing or inhibiting the survival of a virus.

The use of the antiviral polymer material in the production of articles solves the problem of transfer and spread of a viral infection from touching or contacting a contaminated article. As explained above many viruses, such as SARS-COV-2 can survive on a surface for a period of time.

In one embodiment the polymer material of the present invention is effective at destroying or inactivating a virus, wherein the virus is an enveloped virus. In one embodiment the polymer material of the present invention is effective at destroying or inactivating a virus, wherein the virus is selected from a poxvirus, herpesvirus, orthomyxoviridae virus, paramyxoviridae virus, flaviviridae virus, retroviridae virus, filoviridae virus, hepadnaviridae virus and coronavirus. Examples of viruses that can be destroyed or supressed by the antiviral polymer material or an article formed from said antiviral polymer material include type A influenza virus (humans, avian, swine (atypical)), type B influenza virus, parainfluenza virus, (type B and C) hepatitis virus, measles virus, vaccinia virus, herpes virus, Ebola virus, Zica virus, mumps virus, rubella virus, HIV virus, severe acute respiratory syndrome coronavirus (SARS-COV), Middle East Respiratory Syndrome-Related Coronavirus (MERS-COV), and Severe Acute Respiratory Syndrome Coronavirus 2 (SARS-COV-2) and so on.

Thus the present invention is applicable to the eradication and/or prevention of the proliferation of those viruses belonging to or derived from the family of the coronaviridae or coronavirus, especially severe acute respiratory syndrome-related coronavirus (SARS coronavirus), such as SARS-COV-1 or SARS-COV-2.

In the antiviral polymer material of the invention comprising a silane-based quaternary ammonium compound and a polymer, the silane-based quaternary ammonium compound is present in an amount effective to destroy or inactivate at least 95% of viruses, wherein in one embodiment the viruses are enveloped viruses (e.g. a coronavirus such as SARS-COV-2) upon contact with the antiviral polymer material or article comprising said polymer material. Preferably the silane-based quaternary ammonium compound is present in an amount effective to destroy or inactivate at least 96%, or at least 97%, or at least 98% of an enveloped virus upon contact with the antiviral polymer material or article comprising said polymer material. More preferable the silane-based quaternary ammonium compound is present in an amount effective to destroy or inactivate at least 99%, e.g. at least 99.0%, or at least 99.1%, or at least 99.3%, or at least 99.5%, or at least 99.7%, or at least 99.9%, or preferably 99.99% and more preferably 100% of enveloped viruses upon contact with the antiviral polymer material or article comprising said polymer material. As used herein “amount effective” means that the amount of the silane-based quaternary ammonium compound provides a spectrum of antiviral activity sufficient to destroy or inactivate most virus on the antiviral polymer material of the invention or on an article formed from said antiviral polymer material.

In one embodiment, at least 98% of viruses are destroyed or inactivated, preferable at least 99% of viruses are destroyed or inactivated, for example at least 99.0%, or at least 99.1%, or at least 99.3%, or at least 99.5%, or at least 99.7%, or at least 99.9%, or preferably 99.99% and more preferably 100% of virus are destroyed or inactivated, upon contact with the antiviral polymer material of the invention or with an article comprising said antiviral polymer material and wherein said virus is an enveloped virus.

In another aspect of the invention, the antiviral polymer material of the invention can be used for destroying or inactivating a virus. The article may comprise the antiviral polymer material according to the present invention. In one embodiment the virus is an enveloped virus. In one embodiment said virus belongs to or derives from the family of the coronavirus, especially severe acute respiratory syndrome-related coronavirus, such as SARS-COV-1 or SARS-COV-2.

In another aspect, the antiviral polymer material of the invention can be used for making an article capable of destroying or inactivating a virus. In one embodiment the virus is an enveloped virus. In one embodiment said virus belongs to or derives from the family of the coronavirus, preferably severe acute respiratory syndrome-related coronavirus, such as SARS-COV-1 or SARS-COV-2.

In another aspect, the present invention provides a method for destroying or inactivating a virus, wherein said article comprises the antiviral polymer material of the present invention. In one embodiment the virus is an enveloped virus. In one embodiment said virus belongs to or derives from the family of the coronavirus, preferably severe acute respiratory syndrome-related coronavirus, such as SARS-CoV-1 or SARS-COV-2.

In another aspect of the present invention, there is provided a method for eradicating or inactivating a virus from an article and/or for rendering articles resistant to the proliferation of a virus, wherein said article comprises the antiviral polymer material of the present invention. In one embodiment the virus is an enveloped virus. In one embodiment said virus belongs to or derives from the family of the coronavirus, preferably severe acute respiratory syndrome-related coronavirus, such as SARS-CoV-1 or SARS-COV-2.

The terms “eradicate” or “eradication” means that the antiviral polymer material, antiviral agent, articles, uses and methods employed in the practice of the present invention are capable of destroying or inactivating essentially all, e.g., 97%, or 98%, or preferably 99%, or more preferably 99.99%, of the viruses (e.g. enveloped viruses such as coronavirus). Similarly, when used herein, the terms “resistant” or “resistance” mean that the articles comprising the antiviral polymer material in accordance with the present invention will essentially prevent the proliferation of any virus (e.g. enveloped viruses such as coronavirus) that may come in contact with said articles and, preferably, will eradicate all or essentially all viruses that may come in contact with said article.

The amount of silane-based quaternary ammonium compound in the antiviral polymer material is less than 10 wt % (based in the total weight of antiviral polymer material), such as less than 8 wt %, or less than 6 wt %, or less than 5 wt %, e.g. from 0.1 to 9 wt %, or from 0.1 to 7 wt %,or from 0.1 to 6 wt %, or from 0.1 to 5 wt %, or from 0.25 to 5 wt %, or from 0.5 to 5 wt %, or from 0.1 to 3 wt %, or from 0.25 to 3 wt %, or from 0.5 to 3 wt %, or from 0.1 to 2.5 wt %, or from 0.25 to 2.5 wt %, or from 0.5 to 2.5 wt %, or from 0.1 to 2 wt %, or from 0.25 to 2 wt %, or from 0.5 to 2 wt %, or from 0.1 to 1.5 wt %, or from 0.25 to 1.5 wt %, or from 0.5 to 1.5 wt %, or about 1 wt % or about 2 wt %.

In one embodiment of the present invention, the silane-based quaternary ammonium compound is a compound of formula (I) or a polymer (e.g. a homopolymer) thereof:

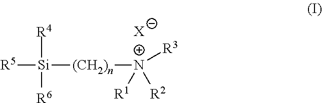

where X⁻ is an anion, e.g. a halide (i.e. F⁻, Cr⁻, Br⁻, I⁻), hydroxyl, acetate, SO₄²⁻, CO₃²⁻ or PO₄³⁻, preferably a halide, especially preferably Cl⁻;
n is an integer from 0 upwards, e.g. from 0 to 20, preferably 1 to 12, especially preferably 2 to 6, particularly preferably 3;
R¹ to R⁶ are independently selected from an organic group, hydrogen or a hydroxy group, preferably hydroxy, hydrogen, alkyl, aryl or alkaryl groups, including alkoxy and aryloxy groups.

By “organic group” is meant a group containing one or more carbon atoms, preferably a group consisting essentially of carbon atoms and hydrogen atoms, optionally further comprising one or more heteroatoms (e.g. N, 0, Si, P, S, etc.). Preferably the R groups have 1 to 30 carbon atoms, especially 1 to 20, e.g. 2 to 12. The R groups may be branched or linear and may contain heteroatoms either in the chain/ring or as part of a substituent.

The R groups of formula (I) may be independently selected from short chain alkyl groups, such as C₁₋₆ alkyl groups (e.g. methyl): C₇₋₂₀ alkyl groups (e.g. C₁₂₋₁₄ alkyl groups) and aralkyl groups, such as benzyl groups.

Preferably at least one, e.g. one, two or three, particularly one or two, of R¹, R² and R³ is a long chain alkyl group, e.g. a C₁₂ to C₂₀ alkyl, especially a C₁₄ to C₁₈ alkyl group.

Preferably at least one, e.g., one, two or three of R⁴, R⁵ and R⁶ are independently selected from an alkoxy group, e.g. propoxy, ethoxy or methoxy, preferably a methoxy group.

In one embodiment, R¹ to R⁶ of formula (I) are independently selected from alkyl or aryl groups, including alkoxy and aryloxy groups. Preferably the R groups have 1 to 30 carbon atoms, especially 1 to 20, e.g. 2 to 12. The R groups may be branched or linear and may contain heteroatoms either in the chain/ring or as part of a substituent.

Preferably at least one, e.g. one, two or three, particularly one or two, of R¹, R² and R³ is a long chain alkyl group, e.g. a C₁₂ to C₂₀ alkyl, especially a C₁₄ to C₁₈ alkyl group.

Preferably at least one, e.g., one, two or three of R⁴, R⁵ and R⁶ are independently selected from an alkoxy group, e.g. propoxy, ethoxy or methoxy, preferably a methoxy group.

Further preferred compounds of formula (I) are those in which one or more of the R groups, especially one or more of R⁴, R⁵ and R⁶ are hydrogen or hydroxy groups.

In one embodiment, the silane-based quaternary ammonium compound is 3-(trihydroxysilyl)propyldimethyl octodecyl ammonium chloride or a polymer (e.g. a homopolymer) thereof, or 3-(trimethoxysilyl)propyldimethyl octodecyl ammonium chloride i.e. a compound of formula (II) or a polymer (e.g. a homopolymer) thereof:

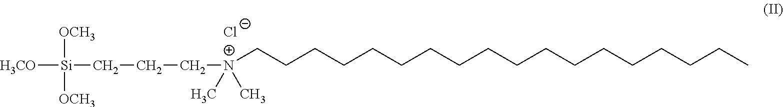 [SMILES: [Cl-] ; CCCCCCCCCCCCCCCCCC[N+](C)(C)CCC[Si](OC)(OC)OC]

3-(trihydroxysilyl)propyldimethyl octodecyl ammonium chloride (shown below as a compound of formula (III))

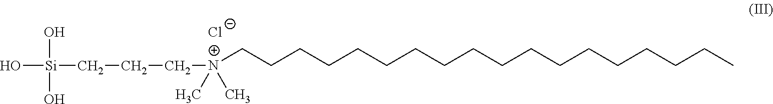 [SMILES: [Cl-] ; CCCCCCCCCCCCCCCCCC[N+](C)(C)CCC[Si](O)(O)O]

The compound of formula (III) is for example available from BIOSAFE Inc. under the name “HM4100” as a polymeric solid silane-based cationic quaternary ammonium salt antimicrobial agent. HM4100 is in the form of a crystalline powder that is thermally stable in injection moulding and extrusion.

In one embodiment, the antiviral polymer material of the present invention comprises a compound of formula (II) or formula (III) and a polymer

In one embodiment, the C₁₈ tail of the compounds of formula (II) or formula (III) are replaced by an alternative long chain alkyl group, e.g. C₁₂ to C₂₀ alkyl group. Additional compounds might differ from those of formulae (II) and (III) in that they comprise a —(CH₂)—₂₋₁₂ linker, preferably —(CH₂)—₂₋₁₀ linker, or a —(CH₂)—₂₋₈ linker, or a —(CH₂)—₂₋₆ linker, between the nitrogen and silicon atoms.

The silane-based quaternary ammonium compounds described above may be employed in monomeric form, polymeric form (e.g. as a homopolymer) or may be co-polymerised with the polymer to form the antiviral polymer material of the invention.

The silane-based quaternary ammonium compounds may be combined with any polymer suitable for making the antiviral polymer material or articles of the invention, e.g. elastomers, silicones, thermoplastics, particularly a thermoplastic. Preferred polymers are polyurethanes, nylon, polyolefins (such as polypropylene (PP), polyethylene (PE), high density polyethylene (HDPE), low density polyethylene (LDPE), linear low density polyethylene (LLDPE)), polyesters, polyethylene terephthalate (PET), polyvinyl chloride (PVC), polystyrene (PS), high impact polystyrene (HIPS), polyamides (PA), acrylonitrile butadiene styrene (ABS), melamine formaldehyde (MF), polycarbonate (PC), elastomers (such as thermoplastic elastomer (TPE)), polysiloxanes/silicones silicone and (e.g. (SI)) polycarbonate/acrylonitrile butadiene styrene (PC/ABS), Petex, derivatives, mixtures and blends thereof. Preferably the polymer is a polyolefin, e.g. polypropylene, or a polymer blend comprising polypropylene.

In one embodiment, the antiviral polymer material of the present invention comprises a compound of formula (I), (II) or (III) and a polypropylene or a polymer blend comprising polypropylene.

The silane-based quaternary ammonium compound and the polymer may be combined in a variety of ways, e.g. a polymer article may have a coating of, or comprising, silane-based quaternary ammonium applied thereto, or the silane-based quaternary ammonium compound may be mixed with, e.g. incorporated into, the polymer using techniques known in the art (e.g. injection moulding or extrusion). Preferably the silane-based quaternary ammonium compound is incorporated into the polymer, e.g. by blending, dissolution or copolymerisation.

The polymer and silane-based quaternary ammonium compound can be combined to form an antiviral polymer material in a variety of ways. The antiviral polymer material according to the invention can be produced by the following processes:
(i) Polymer in solid form (e.g. particles such as powder, beads, pellets, granules or flakes) is coated with a solution or melt of the silane-based quaternary ammonium compound (which may be, but is not necessarily, in polymer or polymerisable form) to create coated solid polymer particles. The thus coated polymer may be ready to use, or in concentrate form, i.e. a concentrated “master-batch” for future blending (e.g. by melting and/or extrusion or injection moulding) with more polymer to produce a material with antiviral properties. The coating of the solid polymer particles is preferably carried out by spraying the polymer particles with the solution of the silane-based quaternary ammonium compound. The coated particles are then preferably dried (e.g. to remove solvent) before further use. Alternatively, polymer can be mixed with the silane-based quaternary ammonium compound in liquid form by means other than by coating polymer particles, e.g. polymer in solid or liquid form may be mixed with silane-based quaternary ammonium compound in liquid form, with or without heating, e.g. the polymer particles may be mixed (e.g. by stirring) in a solution of silane-based quaternary ammonium.
(ii) A polymerisable antiviral monomer (e.g. in solid, liquid, solution or melt form) is copolymerised with a second monomer and/or a polymer to produce a copolymer of the silane-based quaternary ammonium compound with the second monomer and/or the polymer.
(iii) A polymerisable antiviral monomer (e.g. in solid, liquid, solution or melt form) is blended with a second monomer and/or a polymer to produce a homopolymer of silane-based quaternary ammonium compound blended with the second monomer and/or the polymer. In this way a blended polymer comprising a homopolymer of silane-based quaternary ammonium compound is formed.
(iv) A silane-based quaternary ammonium compound (which may be, but is not necessarily, a polymer or polymerisable) in solid form (e.g. particles such as powder, beads, pellets, granules or flakes) is blended with polymer in solid form (e.g. particles such as powder, beads, pellets, granules or flakes), e.g. by melting, mixing, injection moulding and/or extrusion.
(v) Particles comprising the silane-based quaternary ammonium compound and first polymer (e.g. a master-batch as produced by (i) above) are blended with a second polymer (which may be the same or different to the first polymer) in solid form, e.g. by melting, injection moulding or extrusion.
(vi) The solution of the silane-based quaternary ammonium compound in a solvent (or silane-based quaternary ammonium compound in liquid, e.g. melt form) is mixed with polymer in solid form (e.g. particles such as powder, beads, pellets, granules or flakes). Preferably the particles are then dried in order to remove solvent from the pellets.
(vii) The silane-based quaternary ammonium compound (which may be, but is not necessarily, a polymer or polymerisable) in liquid form (e.g. as a solution or melt) is blended with polymer in solid or liquid form (e.g. a melt, a liquid, a solution, or particles such as powder, beads, pellets or flakes), e.g. by melting, mixing, injection moulding and/or extrusion.
(viii) The silane-based quaternary ammonium compound (which may be, but is not necessarily, a polymer or polymerisable) in solid form (e.g. as powder, beads, pellets, granules or flakes) is blended with polymer in solid or liquid form (e.g. a melt, a liquid, a solution, or particles such as powder, beads, pellets or flakes), e.g. by melting, mixing, injection moulding and/or extrusion.

When a solution of the silane-based quaternary ammonium compound is required, the solvent is preferably a polar solvent, for example an alcohol, particularly, methanol, ethanol, butanol, propanol (e.g. isopropyl alcohol).

The above-mentioned second monomer may be the same or different to any one of the monomers that form the main polymer of the antiviral polymer material (e.g. polypropylene).

In another aspect, the invention provides a method of making an antiviral polymer material comprising combining a polymer and a silane-based quaternary ammonium compound by any one of the methods described above.

In one embodiment, a concentrated “master-batch” of the silane-based quaternary ammonium compound in polymer is prepared, for example by one of the methods described above, for later combination with polymer (in e.g. melt form) to produce a blend of the desired concentration of silane-based quaternary ammonium compound in polymer. A typical master-batch composition has a silane-based quaternary ammonium compound content (expressed as a weight percentage of the master-batch) of 0.1 to 25%, e.g. 0.1 to 15%, preferably 0.1 to 10% or 0.2 to 10%, or 0.2 to 6%, or 0.3 to 10%, or 0.3 to 6%, and more preferably of 0.5 to 10%, or 0.5 to 8%, or 0.5 to 7%, or 0.5 to 5% or 0.5 to 3%. The polymer may be in solid form such as powder, beads, pellets or flakes may be coated (e.g. by spraying or mixing) with a solution or melt of the silane-based quaternary ammonium compound to create a coated solid polymer concentrate for future blending to produce a material with antiviral properties. Alternatively, the master-batch may be formed by mixing the silane-based quaternary ammonium compound in solid form with polymer in solid form, e.g. by injection moulding or extrusion.

Alternatively, the silane-based quaternary ammonium compound (e.g. in liquid or granular form) may be added to a melt of the polymer either alone or in a solution at the desired concentration and the melt mixed to dissolve the silane-based quaternary ammonium compound in the polymer melt.

The mixing of the components is effected using typical polymer processing techniques, e.g. melting, mixing, injection moulding and/or extrusion. In general no chemicals are required for processing. In one embodiment, the silane-based quaternary ammonium compound is added (preferably in liquid or granular form) to the polymer. The components are then mixed, optionally with heating, e.g. to melt one or both components. Particularly preferably, the silane-based quaternary ammonium compound and polymer in solid form (and optionally, any other components which are desired in the polymer composition) are extruded (e.g. using a single or twin screw extruder) in a process where the material will be fused to form pellets. Fusion typically takes place at temperatures between 150 and 280° C., preferably between 180° and 240° C. Heating to these temperatures before mixing and extrusion is preferred. The product (e.g. pellets) produced may optionally then be blended (e.g. by melting) with more polymer before being further processed to form articles according to the invention.

Other components may be present in the antiviral polymer material of the invention or the polymer used in said antiviral polymer material. The further components, when present, may be selected from colourants (e.g. dyes), UV inhibitors, surfactants, chain transfer agents and other polymerisation modifiers, cross-linking agents, plasticizers, polymerisation modifiers, property modifiers, stabilizers and mixtures thereof. These additives may be present in typical amounts and may be added at a suitable stage of processing, e.g. when the silane-based quaternary ammonium compound and a polymer are combined, or at a later stage, e.g. when a concentrated “master-batch” comprising silane-based quaternary ammonium compound and polymer is mixed with further polymer.

Thus in another aspect, the present invention also relates to the use of the silane-based quaternary ammonium compounds described herein (e.g. compounds of formula (I), (II), (III) or a polymer thereof) as antiviral agent.

Said antiviral agent (e.g. a silane based quaternary ammonium compound or the compounds of formula (I), (II), (III)) may be present in a material (for example a polymer material) providing an antiviral effect against viruses, such as coronaviruses. The antiviral agent may be present in a polymer material in the amounts and forms described above.

The antiviral agent (e.g. silane based quaternary ammonium compound described herein) may be present in a polymer article either by virtue of being combined with the polymer prior to the production of the article, or by coating the formed article with the antiviral agent according to the invention. Alternatively, only the parts of the article that routinely come into contact with a human or animal are formed from, or coated with, the polymer material comprising the antiviral agent (e.g. the silane based quaternary ammonium compound described herein).

The antiviral polymer material herein described can be used to form or make articles, or can be used (e.g. in liquid, i.e. solution or melt form) to coat a pre-prepared article.

Thus in another aspect, the present invention provides an article comprising the antiviral polymer material of the present invention.

These articles may be made entirely from the antiviral polymer material of the invention or only part of the article may be formed with or from the antiviral polymer material. Alternatively, the article or product may be entirely or partially coated with the antiviral polymer material according to the invention. When only part of the article is formed from the antiviral polymer material, or coated with the antiviral polymer material, that part should preferably be the part that is most frequently in contact with the skin or part of the body, e.g the teeth in the case of a tooth brush. Typically, at least the part most usually in contact with the skin or part of the body is formed from the antiviral polymer material, or is coated with antiviral polymer material. Preferably, the article is made entirely from, or is entirely coated with, the antiviral polymer material. Preferably the entire article (or the part most usually in contact with the skin or part of the body) is made from the antiviral polymer material comprising a silane-based quaternary ammonium compound and a polymer.

The article of the invention comprising an antiviral polymer material as described herein may be any animal and/or human-contact article. The article of the invention may comprise any article suitable to be made from a polymer. The article of the invention may be a fibre, thread, filament, a molded article, nonwoven material, extruded article, woven fabric, web material, a film, a sponge material, a fibrous batt material, a foam material, a sheet and textile.

Further examples of suitable articles comprising the antiviral polymer material of the present invention include, without limitation, toothbrushes and other dental equipment, cleaning brushes, brooms, desks, sticky tape, face mask, a wound dressing, disposable diaper, hair brushes, body brush, nail brushes, combs and other personal care utensils, garments, bedsheets, cleaning cloths, door knobs, food packaging, sponges, wipes, packaging for cosmetics, floor coverings, flooring, cutting boards, bowls, eyeglasses, glasses, helmets, steering wheels, toys, toilet seats, condoms, caps, telephones, kitchen utensils, umbrella handles, handrails, air conditioners and filters, children's chairs, furniture, keyboards, can openers, cooking utensils, credit cards, coatings, and the like.

In one embodiment the article of the invention comprising an antiviral polymer material as described herein is a fibre, thread or filament. The article may be a bristle e.g. brush bristles, toothbrush bristles or a yarn. Preferably the entire fibre, thread, filament or bristle is made from or coated with the antiviral polymer material comprising a silane-based quaternary ammonium compound and a polymer.

In one embodiment the article of the invention comprising an antiviral polymer material as described herein is a brushlike product. Preferably the article comprising the antiviral polymer as described herein above is selected from a toothbrush, a hair brush, nail brush, body brush, face brush, cleaning brush, broom, shaving brush, makeup brush, bath brush, toilet brush, clothes brush, dusting brush, brush head of a vacuum cleaner, upright brush-type vacuum cleaner and an escalator brush.

When the article are fibres, the antivirus polymer material may be used alone or in combination with another type of fibre to make (e.g. weave or knit) a textile with antimicrobial properties. The fibres comprising the antivirus polymer material of the invention be combined (e.g. spun) with other fibres before knitting or weaving, and/or may be combined with other fibres via knitting or weaving. Where the antiviral polymer fibres are used in combination with another fibre, the other fibre is typically a conventional material for making textiles, e.g. a synthetic material such as nylon, polyester, acrylic, polypropylene or a natural material such as wool, silk, cotton. Such fibres, comprising a silane-based quaternary ammonium compound and a polymer as herein described, form a further aspect of the present invention.

In certain embodiments, the article of the invention is made from, or comprises, a textile woven from fibres of antiviral polymer material as herein described. Such textiles, comprising a silane-based quaternary ammonium compound and a polymer as herein described, form a further aspect of the present invention.

The fibres are formed from antiviral polymer material as herein described, (i.e. antiviral polymer material comprising the silane-based quaternary ammonium compounds described herein above and polymer) by conventional means for formation of synthetic fibres, e.g. by injection moulding or extrusion. Typical fibre diameters are 0.05 to 2 mm, or 0.1 to 1.2 mm, preferably 0.05 to 1 mm or 0.05 to 0.5, or more preferable 0.1 to 0.2, e.g. around 0.45 mm, or around 0.3 mm or around 0.2 mm. Fibres can be formed of any practical length, depending on their intended use. For brushes and the like, lengths of 5 to 250 mm, or 10 to 250 mm or 20 to 250 mm, preferably 5 to 200 mm, or 10 to 200 mm or 20 to 200 mm, or 50 to 200 mm are suitable. Particularly, lengths of around 64, 70, 100 and 170 mm are suitable for brush fibres. For manufacture of textiles and fabrics, longer fibres may be required, e.g. up to several thousands of metres. Threads, fibres and yarns may be mono-filaments or made by twisting, otherwise bonding or simply grouping together a number of separate fibre strands to form the fibre/thread/yarn to be used to produce a textile. As noted above, fibres comprising antimicrobial agent and polymer may be combined in these ways with other types of natural or synthetic fibres. Similar methods may be used to make fibres for other uses, e.g. as brush bristles. Fibres of any desired cross-section may be produced using convention techniques such as injection moulding or extrusion. Typical fibre cross-sections for use in the invention are circular, flat, and x-shaped.

The articles of the invention can be made by conventional means. When the entire article is formed from polymer, the antiviral polymer material comprising silane-based quaternary ammonium compound and polymer can be moulded into the shape of the tool using conventional techniques such as extrusion moulding, extrusion blow moulding, rotational moulding, injection moulding or injection blow moulding. Extrusion may be effected, for example, using a twin or single screw extruder. Alternatively, part of the article may be formed from the antiviral polymer material comprising silane-based quaternary ammonium compound and polymer, in which case that part is made as described above with reference to an entire article.

For example, antiviral article may be formed by blending polypropylene with an silane-based quaternary ammonium compound such as a homopolymer of 3-(trihydroxysilyl)propyldimethyl octodecyl ammonium chloride at around 1% wt or 2% wt, based on the total weight of the antiviral polymer material.

The articles of the invention prevent the spread of viruses and viral contamination, such as coronavirus, by destroying or inactivating a virus. Thus the articles of the invention are effective preventing and/or eradicating the proliferation of those viruses belonging to or derived from the family of the coronavirus, especially severe acute respiratory syndrome-related coronavirus (SARS coronavirus), such as SARS-COV-1 or SARS-COV-2.

The use of the above described antiviral polymer material and antiviral agents in the production of articles as herein described forms a further aspect of the invention. The invention thus provides a method for manufacturing an article, particularly an article for use in contact with humans e.g. toothbrush, a hair brush, nail brush, body brush, cleaning brush and broom, wherein said method comprises forming at least part of said article from the antiviral polymer material of the present invention. Preferably the invention provides the use of the antiviral polymer material of the present invention in the production of an article for close contact with a human, e.g. toothbrush, a hair brush, nail brush, body brush, cleaning brush and broom, wherein preferably said antiviral polymer material is a blend of the silane-based silicon quaternary ammonium compound is a compound of formula (I), (II) and/or (III) or a polymer thereof and a polymer, such as polypropylene.

The following examples are provided by way of illustration only and are not intended to limit the scope of invention.

### EXAMPLE 1

### 3-(Trihydroxysilyl)propyldimethyl Octodecyl Ammonium Chloride in Polypropylene at 0.5%. 0.75% and 1.0% by Weight

3-(trihydroxysilyl)propyldimethyl octodecyl ammonium chloride (available in dry particulate form from BIOSAFE Inc., Pittsburgh, USA) was incorporated into fibres of polypropylene (molecular weight of 0.90 g/cm3) by preparing a master-batch containing 2-10% by weight of 3-(trihydroxysilyl)propyldimethyl octodecyl ammonium chloride. The master-batch was prepared by blending polyethylene resin (although polypropylene may also be used) with 3-(trihydroxysilyl)propyldimethyl octodecyl ammonium chloride in an extruder using either a single or twin screw. The recovered pellets were then blended with polypropylene resin and the melt was extruded through a die forming the filaments that were combined to form a yarn.

A ladder series using 3-(trihydroxysilyl)propyldimethyl octodecyl ammonium chloride at 0.5%, 0.75% and 1.0% by weight in the polymer fibres was prepared by the above method.

### EXAMPLE 2

### Incorporation of Antimicrobial Into Polymer

The antimicrobial can be dissolved in a polar solvent (e.g. isopropyl alcohol) and added to the polymer pellets prior to processing. 3-(trihydroxysilyl)propyldimethyl octodecyl ammonium chloride is dissolved in an equal weight of 99.9% isopropyl alcohol. This is added to polypropylene pellets in a suitable amount, e.g. an 3-(trihydroxysilyl)propyldimethyl octodecyl ammonium chloride solution to polymer weight ratio of 2:99 would produce a polymer containing 1% 3-(trihydroxysilyl)propyldimethyl octodecyl ammonium chloride. The polymer pellets are stirred to incorporate the agent evenly and then are dried under ambient conditions in order to remove the solvent (isopropyl alcohol) from the pellets. Within one or two days of drying under ambient conditions, articles can be processed from the resulting antiviral polymer material.

### EXAMPLE 3

### Fibre Manufacture

Granules of 3-(trihydroxysilyl)propyldimethyl octodecyl ammonium chloride were mixed with polypropylene. The mixture was then melted and extruded to form fibres, of varying diameters from 0.1 mm to 1.2 mm. The fibres were then bundled together—each bundle has a diameter of approx 10 cm. The bundles were then cut to the lengths required to produce brush bristles, e.g. 64 or 70 mm in the fibres of a thinner diameter, and 100 mm and 170 mm length with fibres that are 0.45 mm diameter.

### EXAMPLE 4

### Antiviral Efficacy Testing

3-(trihydroxysilyl)propyldimethyl octodecyl ammonium chloride was incorporated into fibres of polypropylene (molecular weight of 0.90 g/cm3) by preparing a master-batch containing 2% by weight of 3-(trihydroxysilyl)propyldimethyl octodecyl ammonium chloride.

Feline coronavirus ATCC VR-989/CRFK cells were inoculated onto a stainless-steel disc and then contacted with a brush made with the fibres according to the invention. This was then neutralised, serially diluted and virus titred in 96-well tissue culture plates to determine the tissue culture infectious dose 50 (TCID50) of surviving virus. The Feline coronavirus ATCC VR-989/CRFK cells were assayed in parallel in each test. TCID50 was determined by the method of Karber.

### Virus, Cells and Controls

The cells used in this study were CRFK cells from ATCC CCL-94, lot 62059946.

The virus used was Feline coronavirus ATCC VR-989 and was supplied from ATCC, BluTest passage number 8.

Virus recovery control: Virus titre is determined for virus in contact with sterile hard water at t=0, t=1 and at t=60. The virus titre after 1 minute is then compared to the recovery of product-treated virus to measure the log reduction in virus titre. The virus titre at 60 minutes is compared to the reference virus inactivation control.

Dry control: The stainless-steel plate was allowed to dry for a 10 minute period after virus contact. After the allotted time, a swab was used to recover a test sample to observe that this drying period had no effect on virucidal activity.

Reference virus inactivation control: Virus is exposed to 0.7% W/V formaldehyde and the recovery of virus determined by TCID50 after 5 and 15 minutes, in order to assess that the test virus has retained reproducible resistance. In addition, the formaldehyde cytotoxicity of neutralised formaldehyde is determined to measure assay sensitivity.

The titre of diluted Feline coronavirus ATCC VR-989 was 4.68×106 log10 TCID50/ml (as determined by the mean value of the control virus titres obtained from the virucidal assay). Dilution of the stock virus was 900 μl of virus to 100 μl BSA.

TCID50 was determined by the method of Karber (1Kärber, G.: Beitrag zur Kollektiven Behandlung Pharmakologischer Reihenversuche. Arch. Exp. Path. Pharmak. 162 (1931): 480-487.). Test virus suspension has at least a concentration which allows the determination of a 4 log10 reduction of the virus titre. The number of infectious virus particles is quantified by using the Median Tissue Culture Infectious Dose (TCID50) assay. The assay works by adding a serial dilution of the virus sample to cells in a 96 well plate format. The type of cell is specifically selected to show a cytopathic effect (CPE), i.e. morphological changes upon infection with the virus or cell death. After an incubation period, the cells are inspected for CPE or cell death and each well is classified as infected or not infected. Colorimetric or fluorometric readouts are also possible, which can increase assay sensitivity. The dilution, at which 50% of the wells show a CPE, is used to calculate the TCID50 of the virus sample. This calculation can generally be done by a variety of mathematical approaches, e.g., the Spearman-Karber method or the Reed-Muench method. Virus quantity is expressed as TCID50/ml.

CRFK cells were seeded onto 96-well plates at a density of 1×10⁵ cells/ml. The cells were incubated at 37° C. and 5% CO2 overnight.

Controls

| Virus Recovery | | Virus Recovery | | Virus Recovery | | No column Control | | | |
|---|---|---|---|---|---|---|---|---|---|
| 0 min | | 60 secs | | 60 min | | 60 secs | | Dry control 10 mins | |
| raw data | TCID₅₀/ml | raw data | TCID₅₀/ml | raw data | TCID₅₀/ml | raw data | TCID₅₀/ml | raw data | TCID₅₀/ml |
| 4.50 | 1.00E+06 | 4.50 | 1.00E+06 | 4.17 | 4.64E+05 | 4.50 | 1.00E+06 | 4.17 | 4.64E+05 |
| [symbol] | 1.00E+06 | [symbol] | 1.00E+06 | [symbol] | 4.64E+05 | [symbol] | 1.00E+06 | [symbol] | 4.64E+05 |
| | 6.00 | | 6.00 | | 5.67 | | 6.00 | | 5.67 |

| Formaldehyde reference inactivation controls | | | | | | | |
|---|---|---|---|---|---|---|---|
| | | | 0.7% Formaldehyde | | | | |
| Cytotoxicity | | Exposure | 30 mins | | 60 mins | | |
| raw data | TCID₅₀/ml | time | raw data | TCID₅₀/ml | raw data | TCID₅₀/ml | Stock Virus (TCID₅₀) |
| 1.00 | 3.16E+02 | | 1.00 | 3.16E+02 | 1.00 | 3.16E+02 | 5.17 |
| [symbol] | 3.16E+02 | | [symbol] | 3.16E+02 | [symbol] | 3.16E+02 | 4.68E+06 |
| | 2.50 | log | | 2.50 | | 2.50 | [symbol] |
| | | log | | 3.17 | | 3.17 | |
| | | difference | | | | | |

[symbol]

indicates data missing or illegible when filed

### Verification of the Methodology:

The test was only valid if the following criteria are fulfilled:
a) Test virus suspension has at least a concentration which allows the determination of a 4 log10 reduction of the virus titre.
b) Detectable titre reduction is at least 4 log10.
c) Difference of the logarithmic titre of the virus control minus the logarithmic titre of the test virus in the reference inactivation test is between −0.5 and −2.5 after 30 min and between −2 and −4.5 after 60 min for virus.
d) Cytotoxicity of the product solution does not affect cell morphology and growth or susceptibility for the test virus in the dilutions of the test mixtures which are necessary to demonstrate a 4 log 10 reduction of the virus.
e) A difference of <0.5 log10 should be observed between virus recovered directly from the virus recovery control at 60 minutes and virus from the same control recovered through an Illustra Microspin S-400 HR column.

### Contact:

Feline coronavirus ATCC VR-989 was inoculated onto a stainless-steel coupon (50 ul virus and BSA mix).

A brush made with fibres according to the invention was passed through the virus suspension. In test (A) 4 consecutive passes of the brush in unique directions were performed and the total contact time for the 4 consecutive passes was less than 2 seconds with the test for presence of virus being carried out after 30 seconds from completion of last pass. In test (B) the contact time was 60 seconds (60 seconds of constant brushing in random and varied directions).

Test Results

| Concentration | Replicate 1 | | Replicate 2 | | Replicate 3 | |
|---|---|---|---|---|---|---|
| Exposure Time | data | TCID₅₀/ml | data | TCID₅₀/ml | data | TCID₅₀/ml |
| t = 30 seconds | 2.33 | 6.81E+03 | 2.33 | 6.81E+03 | 2.17 | 4.64E+03 |
| Raw Data | 662000 | 6.81E+03 | 662000 | 6.81E+03 | 661000 | 4.64E+03 |
| log | | 3.83 | | 3.83 | | 3.67 |
| log difference | | 2.17 | | 2.17 | | 2.33 |
| | | | | | Mean: | 2.22 |
| t = 60 seconds | 0.00 | 3.16E+01 | 0.17 | 4.64E+01 | 0.17 | 4.64E+01 |
| Raw Data | 000000 | 3.16E+01 | 100000 | 4.64E+01 | 100000 | 4.64E+01 |
| log | | 1.50 | | 1.67 | | 1.67 |
| log difference | | 4.50 | | 4.33 | | 4.33 |
| | | | | | Mean: | 4.30 |

Summary Table

| | [symbol] | | Level of | [symbol] | | | | | [symbol] |
|---|---|---|---|---|---|---|---|---|---|
| Product: | [symbol] | Concentration | cytotoxicity | 0 min | 30 secs | 60 secs | 15 mins | 60 min | [symbol] |
| [symbol] | 0.3 g/l [symbol] | Replicate 3 | 6.00 | [symbol] | 3.67 | 1.67 | n.a. | n.a. | <60 secs |
| fibre | | Replicate 2 | 6.00 | n.a. | 3.83 | 1.67 | n.a. | n.a. | <60 secs |
| | | Replicate 1 | 6.00 | n.a. | 3.83 | 1.56 | n.a. | n.a. | <60 secs |
| Virus Control | CLEAN | | | 6.00 | n.a. | [symbol] | n.a. | 3.67 | [symbol] |
| | | | | | | | 30 min | 60 min | |
| [symbol] | PBS | 0.7% (w/v) | [symbol] | | | | 2.50 | 2.50 | >60 mins |

[symbol]

indicates data missing or illegible when filed

The tested fibres (A) showed virucidal activity as tested under the above conditions and reduced the amount of virus by 2.22 log₁₀, >99.0%.

The tested fibres (B) showed virucidal activity as tested after 60 seconds of constant brushing at 20° C. under clean conditions (0.3 g/l bovine albumin) Feline coronavirus ATCC VR-989/CRFK cells.

1. Use of a silane-based quaternary ammonium compound as an antiviral agent.

2. The use of claim 1 wherein the silane-based silicon quaternary ammonium compound is a compound of formula (I) or a polymer thereof: 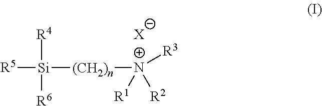
wherein X is a halide;
n is an integer from 2 to 6 and
R¹ to R⁶ are independently selected from an organic group, hydrogen or a hydroxy group.

3. The use of claim 2 wherein R¹ to R⁶ are independently selected from alkyl or aryl groups, including alkoxy and aryloxy groups.

4. The use of claim 3 wherein one or more of R¹ to R⁶ are hydrogen or hydroxy groups, wherein optionally one or more of R⁴, R⁵ and R⁶ are hydrogen or hydroxy groups.

5. The use of claim 1, wherein the silane-based quaternary ammonium compound is a compound of formula (II) or a polymer thereof: 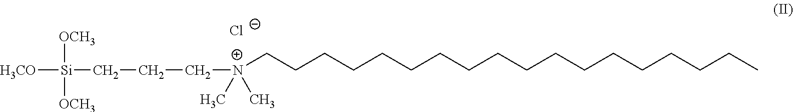 [SMILES: [Cl-] ; CCCCCCCCCCCCCCCCCC[N+](C)(C)CCC[Si](OC)(OC)OC]
or,
said silane-based quaternary ammonium compound is a compound of formula (III) or a polymer thereof:

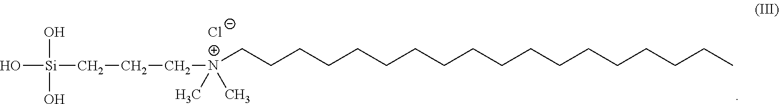 [SMILES: [Cl-] ; CCCCCCCCCCCCCCCCCC[N+](C)(C)CCC[Si](O)(O)O]

6. The use of claim 1, wherein said silane-based quaternary ammonium compound exhibits antiviral activity against an enveloped virus.

7. The use of claim 1, wherein said silane-based quaternary ammonium compound exhibits antiviral activity against a Coronavirus.

8. The use of claim 7 wherein the Coronavirus is a severe acute respiratory syndrome coronavirus 2 (SARS-COV-2).

9. An antiviral polymer material comprising a silane-based silicon quaternary ammonium compound and a polymer.

10. The antiviral polymer material of claim 9 wherein the silane-based silicon quaternary ammonium compound is a compound of formula (I) or a polymer thereof: 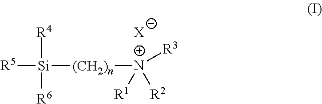
wherein X is a halide;
n is an integer from 2 to 6 and
R¹ to R⁶ are independently selected from an organic group, hydrogen or a hydroxy group.

11. The antiviral polymer material of claim 10 wherein R¹ to R⁶ are independently selected from alkyl or aryl groups, including alkoxy and aryloxy groups.

12. The antiviral polymer material of claim 11 wherein one or more of R¹ to R⁶ are hydrogen or hydroxy groups, wherein optionally one or more of R⁴, R⁵ and R⁶ are hydrogen or hydroxy groups.

13. The antiviral polymer material of claim 9, wherein the silane-based quaternary ammonium compound is a compound of formula (II) or a polymer thereof: 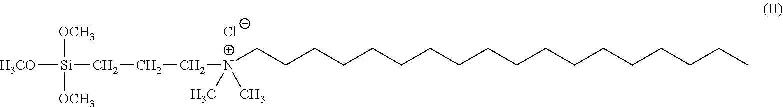 [SMILES: [Cl-] ; CCCCCCCCCCCCCCCCCC[N+](C)(C)CCC[Si](OC)(OC)OC]
or,
said silane-based quaternary ammonium compound is a compound of formula (III) or a polymer thereof:

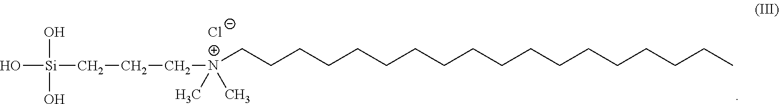 [SMILES: [Cl-] ; CCCCCCCCCCCCCCCCCC[N+](C)(C)CCC[Si](O)(O)O]

14. The antiviral polymer material of claim 9, wherein the polymer is polypropylene or a polymer blend comprising polypropylene.

15. The antiviral polymer material of claim 9, wherein the amount of the silane-based quaternary ammonium compound is 0.1 to 10 wt % based on the total weight of silane-based quaternary ammonium compound and polymer.

16. The use of claim 1 wherein the silane-based quaternary ammonium compound is further combined with a polymer to create an antiviral polymer material for destroying or inactivating a virus on an article comprising the antiviral polymer material.

17. The use of claim 1 wherein the silane-based quaternary ammonium compound is further combined with a polymer to create an antiviral polymer material that is incorporated into an article capable of destroying or inactivating a virus.

18. A method for destroying or inactivating a virus on an article, comprising contacting the virus with the antiviral polymer material.

19. The method of claim 18, wherein said article comprises the antiviral polymer material according to claim 9.

20. The use of claim 16 wherein the virus is an enveloped virus.

21. The use of claim 16 wherein the virus is a Coronavirus.

22. The use of claim 16 wherein the virus is a severe acute respiratory syndrome coronavirus 2 (SARS-COV-2).

23. The method of claim 18, wherein prior to contacting the virus the antiviral polymer material is created by combining a polymer and a silane-based quaternary ammonium compound.

24. The antiviral polymer material of claim 9 further adapted to be formed into an article comprising the antiviral polymer material.

25. The antiviral polymer material of claim 24, wherein the article is selected from a human-contact product, fibre, filament, molded article, nonwoven material, extruded article, woven fabric, web material, film, sponge material, fibrous batt material, foam material, sheet and textile.
